(19) United States
(12) Patent Application Publication
(10) Pub. No.: US 2023/0130879 A1
(43) Pub. Date: Apr. 27, 2023

(54) FUEL CELL POWER GENERATION SYSTEM

(71) Applicant: MITSUBISHI HEAVY INDUSTRIES, LTD., Tokyo (JP)

(72) Inventors: Yasushi Iwai, Tokyo (JP); Norihisa Matake, Tokyo (JP); Hiroyuki Ozawa, Yokohama-shi (JP); Yoshiki Kato, Yokohama-shi (JP); Nagao Hisatome, Yokohama-shi (JP)

(73) Assignee: MITSUBISHI HEAVY INDUSTRIES, LTD., Tokyo (JP)

(21) Appl. No.: 17/915,400

(22) PCT Filed: Feb. 18, 2021
(86) PCT No.: PCT/JP2021/006187

§ 371 Date: Sep. 28, 2022

(30) Foreign Application Priority Data
Apr. 6, 2020 (JP) 2020-068028

(51) Int. Cl. H01M 8/04111; H01M 8/04858

(52) U.S. Cl. CPC H01M 8/04111; H01M 8/04925

(57) ABSTRACT

A fuel cell power generation system includes: a fuel cell; at least one compressor disposed on an oxidant supply line for supplying an oxidizing gas to the fuel cell; a first motor configured to drive a first compressor among the at least one compressor; and at least one power converter disposed between the first motor and a power grid, and capable of adjusting a torque of the first motor.

### TECHNICAL FIELD

The present disclosure relates to a fuel cell power generation system.

### BACKGROUND

As a power generation system including a fuel cell, a pressurized fuel cell power generation system is proposed which is configured such that a pressurized oxidizing gas (for example, air) is supplied to an oxygen-side electrode of the fuel cell.

For example, Patent Document 1 discloses a fuel cell system that includes a pressurized air supply system for supplying air which is compressed by a compressor driven by a turbine to a cathode of a fuel cell. In the pressurized air supply system, during a normal operation of the fuel cell system, the above-described turbine is driven with a combustion gas which is generated by combustion of an exhaust fuel gas from an anode of the fuel cell and exhaust air from the cathode of the fuel cell. Further, Patent Document 1 describes that when the fuel cell system and the pressurized air supply system are started, a motor assists driving of the compressor until an output of the turbine for driving the compressor becomes sufficiently high.

### CITATION LIST

### Patent Literature

Patent Document 1: JP6591112B

### SUMMARY

### Technical Problem

Meanwhile, in a normal operation of a pressurized fuel cell power generation system, an output of a fuel cell may be changed (increased or decreased) according to an output demand. At this time, the amount of fuel supplied to the fuel cell can be increased or decreased relatively rapidly according to the output demand by, for example, adjusting the opening degree of a fuel supply valve. On the other hand, however, it may be difficult to rapidly change the supply amount of an oxidizing gas to the fuel cell. This is because, for example, if the turbine is driven by using the exhaust gas from the fuel cell, although the oxidizing gas supply amount to the fuel cell by the compressor driven by the turbine depends on the amount or the temperature of the exhaust gas from the fuel cell, since the volume of the fuel cell is relatively large, it is difficult to rapidly increase or decrease the amount or the temperature of the exhaust gas from the fuel cell. Therefore, the output change rate of the fuel cell cannot be increased, and the load followability may not be sufficient in actual operation.

In particular, when incorporating into a power grid with large load fluctuations, for example, renewable energy such as a solar cell and wind power generation, better load followability and operational stability are required.

In view of the above, an object of at least one embodiment of the present invention is to provide a fuel cell power generation system capable of increasing the output change rate of a fuel cell.

### Solution to Problem

A fuel cell power generation system according to at least one embodiment of the present invention includes: a fuel cell; at least one compressor disposed on an oxidant supply line for supplying an oxidizing gas to the fuel cell; a first motor configured to drive a first compressor among the at least one compressor; and a power converter disposed between the first motor and a power grid, and capable of adjusting a torque of the first motor.

### Advantageous Effects

According to at least one embodiment of the present invention, a fuel cell power generation system is provided which is capable of increasing the output change rate of a fuel cell.

### BRIEF DESCRIPTION OF DRAWINGS

FIG. 1 is a schematic view of a SOFC module (fuel cell module) according to an embodiment.

FIG. 2 is a schematic cross-sectional view of a SOFC cartridge (fuel cell cartridge) composing the SOFC module (fuel cell module) according to an embodiment.

FIG. 3 is a schematic cross-sectional view of a cell stack composing the SOFC module (fuel cell module) according to an embodiment.

FIG. 4 is a schematic view showing the configuration of a fuel cell power generation system according to an embodiment.

FIG. 5 is a schematic view showing the configuration of the fuel cell power generation system according to an embodiment.

FIG. 6 is a schematic view showing the configuration of the fuel cell power generation system according to an embodiment.

FIG. 7 is a schematic view showing the configuration of the fuel cell power generation system according to an embodiment.

FIG. 8 is a schematic view showing the configuration of the fuel cell power generation system according to an embodiment.

FIG. 9 is a schematic view showing the configuration of the fuel cell power generation system according to an embodiment.

FIG. 10 is a schematic view showing the configuration of the fuel cell power generation system according to an embodiment.

FIG. 11 is a schematic view showing the configuration of a typical fuel cell power generation system.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

In the following, for descriptive convenience, positional relationships among respective components described using expressions “upper” and “lower” with reference to the drawing indicate the vertically upper side and the vertically lower side, respectively. Further, in the present embodiment, as long as the same effect is obtained in the up-down direction and the horizontal direction, the up-down direction in the drawing is not necessarily limited to the vertical up-down direction but may correspond to, for example, the horizontal direction orthogonal to the vertical direction.

Hereinafter, an embodiment in which a solid oxide fuel cell (SOFC) is adopted as a fuel cell constituting a fuel cell power generation system will be described. However, in some embodiments, as the fuel cell constituting the fuel cell power generation system, a fuel cell of a type other than the SOFC (for example, molten-carbonate fuel cells (MCFC), etc.) may be adopted.

(Configuration of Fuel Cell)

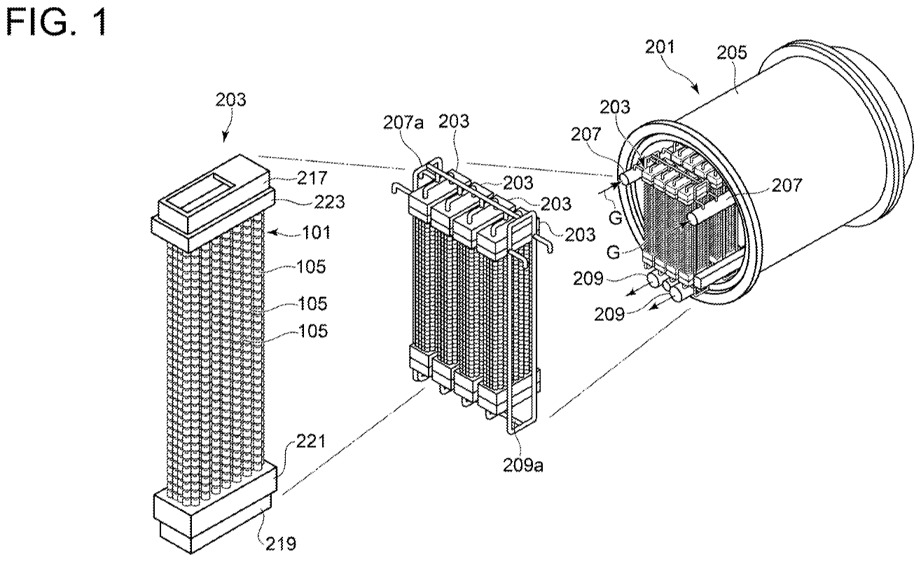

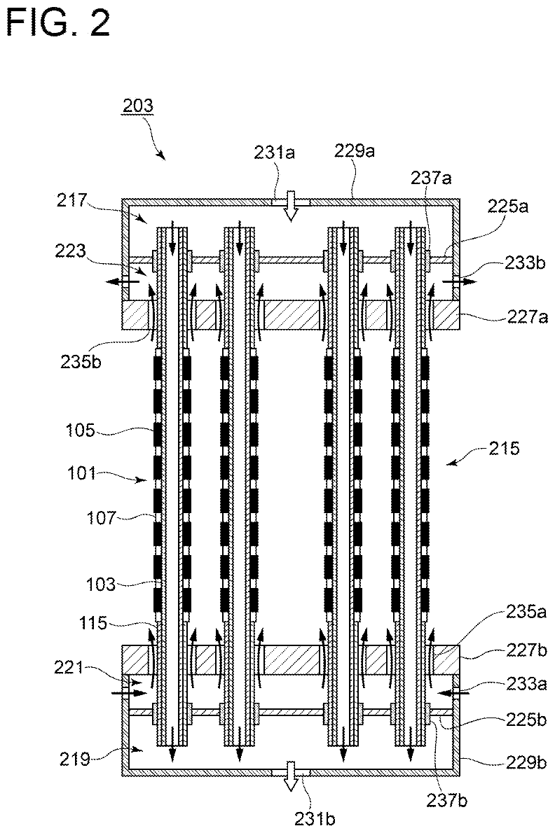

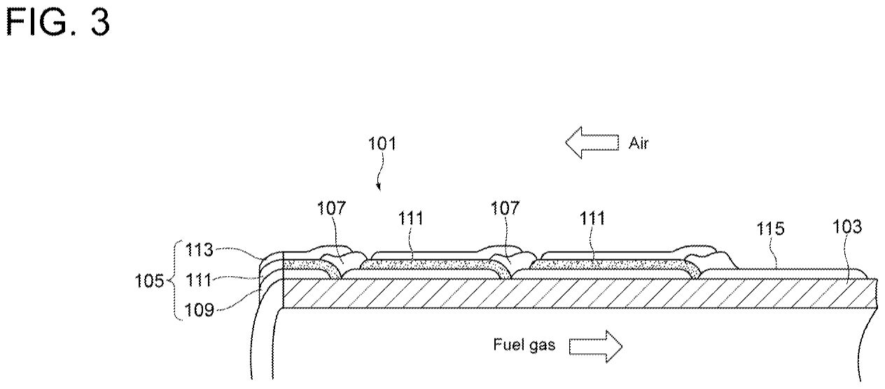

First, a fuel cell constituting a fuel cell power generation system according to some embodiments will be described with reference to FIGS. 1 to 3. The fuel cell in the present specification may be a fuel cell module, a fuel cell cartridge, or a cell stack described below. FIG. 1 is a schematic view of a SOFC module (fuel cell module) according to an embodiment. FIG. 2 is a schematic cross-sectional view of a SOFC cartridge (fuel cell cartridge) composing the SOFC module (fuel cell module) according to an embodiment. FIG. 3 is a schematic cross-sectional view of a cell stack composing the SOFC module (fuel cell module) according to an embodiment.

As shown in FIG. 1, a SOFC module (fuel cell module) 201 includes, for example, a plurality of SOFC cartridges (fuel cell cartridges) 203 and a pressure vessel 205 for housing the plurality of SOFC cartridges 203. Although FIG. 1 illustrates a cylindrical SOFC cell stack 101, the present invention is not necessarily limited thereto and, for example, a flat cell stack may be used. Further, the SOFC module 201 includes fuel gas supply pipes 207, a plurality of fuel gas supply branch pipes 207a and fuel gas exhaust pipes 209, and a plurality of fuel gas exhaust branch pipes 209a. Furthermore, the SOFC module 201 includes an oxidizing gas supply pipe (not shown), an oxidizing gas supply branch pipe (not shown) and an oxidizing gas exhaust pipe (not shown), and a plurality of oxidizing gas exhaust branch pipes (not shown).

The fuel gas supply pipes 207 are disposed in the pressure vessel 205, are connected to a fuel gas supply part for supplying a fuel gas having a predetermined gas composition and a predetermined flow rate according to a power generation amount of the SOFC module 201, and are connected to the plurality of fuel gas supply branch pipes 207a. The fuel gas supply pipes 207 branch and introduce the predetermined flow rate of the fuel gas, which is supplied from the fuel gas supply part described above, to the plurality of fuel gas supply branch pipes 207a. Further, the fuel gas supply branch pipes 207a are connected to the fuel gas supply pipes 207 and are connected to the plurality of SOFC cartridges 203. The fuel gas supply branch pipes 207a introduce the fuel gas supplied from the fuel gas supply pipes 207 to the plurality of SOFC cartridges 203 at the substantially equal flow rate, and substantially uniformize power generation performance of the plurality of SOFC cartridges 203.

The fuel gas exhaust branch pipes 209a are connected to the plurality of SOFC cartridges 203 and are connected to the fuel gas exhaust pipes 209. The fuel gas exhaust branch pipes 209a introduce the exhaust fuel gas exhausted from the SOFC cartridges 203 to the fuel gas exhaust pipes 209. Further, the fuel gas exhaust pipes 209 are connected to the plurality of fuel gas exhaust branch pipes 209a, and a part of each of the fuel gas exhaust pipes 209 is disposed outside the pressure vessel 205. The fuel gas exhaust pipes 209 introduce the exhaust fuel gas derived from the fuel gas exhaust branch pipes 209a at the substantially equal flow rate to the outside of the pressure vessel 205.

The pressure vessel 205 is operated at an internal pressure of 0.1 MPa to approximately 3 MPa and an internal temperature of atmospheric temperature to approximately 550° C., and thus a material is used which has pressure resistance and corrosion resistance to an oxidizing agent such as oxygen contained in an oxidizing gas. For example, a stainless steel material such as SUS304 is suitable.

Herein, in the present embodiment, a mode is described in which the plurality of SOFC cartridges 203 are assembled and housed in the pressure vessel 205. However, the present invention is not limited thereto, and for example, a mode may be adopted in which the SOFC cartridges 203 are housed in the pressure vessel 205 without being assembled.

As shown in FIG. 2, the SOFC cartridge 203 includes the plurality of cell stacks 101, a power generation chamber 215, a fuel gas supply header 217, a fuel gas exhaust header 219, an oxidizing gas (air) supply header 221, and an oxidizing gas exhaust header 223. Further, the SOFC cartridge 203 includes an upper tube plate 225a, a lower tube plate 225b, an upper heat insulating body 227a, and a lower heat insulating body 227b. In the present embodiment, the fuel gas supply header 217, the fuel gas exhaust header 219, the oxidizing gas supply header 221, and the oxidizing gas exhaust header 223 are disposed as shown in FIG. 2, whereby the SOFC cartridge 203 has a structure such that the fuel gas and the oxidizing gas oppositely flow inside and outside the cell stack 101. However, this is not always necessary and, for example, the fuel gas and the oxidizing gas may flow in parallel inside and outside the cell stack 101 or the oxidizing gas may flow in a direction orthogonal to the longitudinal direction of the cell stack 101.

The power generation chamber 215 is an area formed between the upper heat insulating body 227a and the lower heat insulating body 227b. The power generation chamber 215 is an area in which a fuel cell 105 of the cell stack 101 is disposed, and is an area in which the fuel gas and the oxidizing gas are electrochemically reacted to generate electricity. Further, a temperature in the vicinity of the central portion of the power generation chamber 215 in the longitudinal direction of the cell stack 101 is monitored by a temperature measurement part (a temperature sensor, a thermocouple, etc.), and becomes a high temperature atmosphere of approximately 700° C. to 1,000° C. during a steady operation of the fuel cell module 201.

The fuel gas supply header 217 is an area surrounded by an upper casing 229a and the upper tube plate 225a of the SOFC cartridge 203, and communicates with the fuel gas supply branch pipe 207a through a fuel gas supply hole 231a disposed in the upper portion of the upper casing 229a. Further, the plurality of cell stacks 101 are joined to the upper tube plate 225a by a sealing member 237a, and the fuel gas supply header 217 introduces the fuel gas, which is supplied from the fuel gas supply branch pipe 207a via the fuel gas supply hole 231a, into substrate tubes 103 of the plurality of cell stacks 101 at the substantially uniform flow rate and substantially uniformizes the power generation performance of the plurality of cell stacks 101.

The fuel gas exhaust header 219 is an area surrounded by a lower casing 229b and the lower tube plate 225b of the SOFC cartridge 203, and communicates with the fuel gas exhaust branch pipe 209a (not shown) through a fuel gas exhaust hole 231b provided in the lower casing 229b. Further, the plurality of cell stacks 101 are joined to the lower tube plate 225b by a sealing member 237b, and the fuel gas exhaust header 219 collects the exhaust fuel gas, which is supplied to the fuel gas exhaust header 219 through the inside of the substrate tubes 103 of the plurality of cell stacks 101, and introduces the collected exhaust fuel gas to the fuel gas exhaust branch pipe 209a via the fuel gas exhaust hole 231b.

The oxidizing gas having the predetermined gas composition and the predetermined flow rate is branched to the oxidizing gas supply branch pipe according to the power generation amount of the SOFC module 201, and is supplied to the plurality of SOFC cartridges 203. The oxidizing gas supply header 221 is an area surrounded by the lower casing 229b, the lower tube plate 225b, and the lower heat insulating body (support) 227b of the SOFC cartridge 203, and communicates with the oxidizing gas supply branch pipe (not shown) through an oxidizing gas supply hole 23a disposed in a side surface of the lower casing 229b. The oxidizing gas supply header 221 introduces the predetermined flow rate of the oxidizing gas, which is supplied from the oxidizing gas supply branch pipe (not shown) via the oxidizing gas supply hole 233a, to the power generation chamber 215 via an oxidizing gas supply gap 235a described later.

The oxidizing gas exhaust header 223 is an area surrounded by the upper casing 229a, the upper tube plate 225a, and the upper heat insulating body (support) 227a of the SOFC cartridge 203, and communicates with the oxidizing gas exhaust branch pipe (not shown) through an oxidizing gas exhaust hole 23b disposed in a side surface of the upper casing 229a. The oxidizing gas exhaust header 223 introduces the exhaust oxidized gas, which is supplied to the oxidizing gas exhaust header 223 via an oxidizing gas exhaust gap 235b described later, from the power generation chamber 215 to the oxidizing gas exhaust branch pipe (not shown) via the oxidizing gas exhaust hole 233b.

The upper tube plate 225a is fixed to side plates of the upper casing 229a such that the upper tube plate 225a, a top plate of the upper casing 229a, and the upper heat insulating body 227a are substantially parallel to each other, between the top plate of the upper casing 229a and the upper heat insulating body 227a. Further, the upper tube plate 225a has a plurality of holes corresponding to the number of cell stacks 101 provided in the SOFC cartridge 203, and the cell stacks 101 are inserted into the holes, respectively. The upper tube plate 225a air-tightly supports one end of each of the plurality of cell stacks 101 via either or both of the sealing member 237a and an adhesive material, and isolates the fuel gas supply header 217 from the oxidizing gas exhaust header 223.

The upper heat insulating body 227a is disposed at a lower end of the upper casing 229a such that the upper heat insulating body 227a, the top plate of the upper casing 229a, and the upper tube plate 225a are substantially parallel to each other, and is fixed to the side plates of the upper casing 229a. Further, the upper heat insulating body 227a is provided with a plurality of holes corresponding to the number of cell stacks 101 provided in the SOFC cartridge 203. Each of the holes has a diameter which is set to be larger than an outer diameter of the cell stack 101. The upper heat insulating body 227a includes the oxidizing gas exhaust gap 235b which is formed between an inner surface of the hole and an outer surface of the cell stack 101 inserted through the upper heat insulating body 227a.

The upper heat insulating body 227a separates the power generation chamber 215 and the oxidizing gas exhaust header 223, and suppresses a decrease in strength or an increase in corrosion by an oxidizing agent contained in the oxidizing gas due to an increased temperature of the atmosphere around the upper tube plate 225a. The upper tube plate 225a or the like is made of a metal material having high temperature durability such as Inconel, and thermal deformation is prevented which is caused by exposing the upper tube plate 225a or the like to a high temperature in the power generation chamber 215 and increasing a temperature difference in the upper tube plate 225a or the like. Further, the upper heat insulating body 227a introduces an exhaust oxidized gas, which has passed through the power generation chamber 215 and exposed to the high temperature, to the oxidizing gas exhaust header 223 through the oxidizing gas exhaust gap 235b.

According to the present embodiment, due to the structure of the SOFC cartridge 203 described above, the fuel gas and the oxidizing gas oppositely flow inside and outside the cell stack 101. Consequently, the exhaust oxidized gas exchanges heat with the fuel gas supplied to the power generation chamber 215 through the inside of the substrate tube 103, is cooled to a temperature at which the upper tube plate 225a or the like made of the metal material is not subjected to deformation such as buckling, and is supplied to the oxidizing gas exhaust header 223. Further, the fuel gas is raised in temperature by the heat exchange with the exhaust oxidized gas exhausted from the power generation chamber 215 and supplied to the power generation chamber 215. As a result, the fuel gas, which is preheated and raised in temperature to a temperature suitable for power generation without using a heater or the like, can be supplied to the power generation chamber 215.

The lower tube plate 225b is fixed to side plates of the lower casing 229b such that the lower tube plate 225b, a bottom plate of the lower casing 229b, and the lower heat insulating body 227b are substantially parallel to each other, between the bottom plate of the lower casing 229b and the lower heat insulating body 227b. Further, the lower tube plate 225b has a plurality of holes corresponding to the number of cell stacks 101 provided in the SOFC cartridge 203, and the cell stacks 101 are inserted into the holes, respectively. The lower tube plate 225b air-tightly supports another end of each of the plurality of cell stacks 101 via either or both of the sealing member 237b and the adhesive material, and isolates the fuel gas exhaust header 219 from the oxidizing gas supply header 221.

The lower heat insulating body 227b is disposed at an upper end of the lower casing 229b such that the lower heat insulating body 227b, the bottom plate of the lower casing 229b, and the lower tube plate 225b are substantially parallel to each other, and is fixed to the side plates of the lower casing 229b. Further, the lower heat insulating body 227b is provided with a plurality of holes corresponding to the number of cell stacks 101 provided in the SOFC cartridge 203. Each of the holes has a diameter which is set to be larger than the outer diameter of the cell stack 101. The lower heat insulating body 227b includes the oxidizing gas supply gap 235a which is formed between an inner surface of the hole and an outer surface of the cell stack 101 inserted through the lower heat insulating body 227b.

The lower heat insulating body 227b separates the power generation chamber 215 and the oxidizing gas supply header 221, and suppresses the decrease in strength or the increase in corrosion by the oxidizing agent contained in the oxidizing gas due to an increased temperature of the atmosphere around the lower tube plate 225b. The lower tube plate 225b or the like is made of the metal material having high temperature durability such as Inconel, and thermal deformation is prevented which is caused by exposing the lower tube plate 225b or the like to a high temperature and increasing a temperature difference in the lower tube plate 225b or the like. Further, the lower heat insulating body 227b introduces the oxidizing gas, which is supplied to the oxidizing gas supply header 221, to the power generation chamber 215 through the oxidizing gas supply gap 235a.

According to the present embodiment, due to the structure of the SOFC cartridge 203 described above, the fuel gas and the oxidizing gas oppositely flow inside and outside the cell stack 101. Consequently, the exhaust fuel gas having passed through the power generation chamber 215 through the inside of the substrate tube 103 exchanges heat with the oxidizing gas supplied to the power generation chamber 215, is cooled to a temperature at which the lower tube plate 225b or the like made of the metal material is not subjected to deformation such as buckling, and is supplied to the fuel gas exhaust header 219. Further, the oxidizing gas is raised in temperature by the heat exchange with the exhaust fuel gas and supplied to the power generation chamber 215. As a result, the oxidizing gas, which is raised to a temperature needed for power generation without using the heater or the like, can be supplied to the power generation chamber 215.

After being derived to the vicinity of the end of the cell stack 101 by a lead film 115 which is made of Ni/YSZ or the like disposed in the plurality of fuel cells 105, DC power generated in the power generation chamber 215 is collected to a power collector rod (not shown) of the SOFC cartridge 203 via a power collector plate (not shown), and is taken out of each SOFC cartridge 203. The DC power derived to the outside of the SOFC cartridge 203 by the power collector rod interconnects the generated power of each SOFC cartridge 203 to a predetermined series number and parallel number, and is derived to the outside of the SOFC module 201, is converted into predetermined AC power by a power conversion device (an inverter or the like) such as a power conditioner (not shown), and is supplied to a power supply destination (for example, a load system or a power grid).

As shown in FIG. 3, the cell stack 101 includes the cylindrical-shaped substrate tube 103 as an example, the plurality of fuel cells 105 formed on an outer peripheral surface of the substrate tube 103, and an interconnector 107 formed between the adjacent fuel cells 105. Each of the fuel cells 105 is formed by laminating a fuel-side electrode 109, an electrolyte 111, and an oxygen-side electrode 113. Further, the cell stack 101 includes the lead film 115 electrically connected to the oxygen-side electrode 113 of the fuel cell 105 formed at farthest one end of the substrate tube 103 in the axial direction via the interconnector 107 and includes the lead film 115 electrically connected to the fuel-side electrode 109 of the fuel cell 105 formed at farthest another end, among the plurality of fuel cells 105 formed on the outer peripheral surface of the substrate tube 103.

The substrate tube 103 is made of a porous material and includes, for example, CaO stabilized ZrO₂ (CSZ), a mixture (CSZ+NiO) of CSZ and nickel oxide (NiO), or Y₂O₃ stabilized ZrO₂ (YSZ), MgAl₂O₄ or the like as a main component. The substrate tube 103 supports the fuel cells 105, the interconnector 107, and the lead film 115, and diffuses the fuel gas supplied to an inner peripheral surface of the substrate tube 103 to the fuel-side electrode 109 formed on the outer peripheral surface of the substrate tube 103 via a pore of the substrate tube 103.

The fuel-side electrode 109 is composed of an oxide of a composite material of Ni and a zirconia-based electrolyte material and, for example, Ni/YSZ is used. The fuel-side electrode 109 has a thickness of 50 μm to 250 μm, and the fuel-side electrode 109 may be formed by screen-printing a slurry. In this case, in the fuel-side electrode 109, Ni which is the component of the fuel-side electrode 109 has catalysis on the fuel gas. The catalysis reacts the fuel gas supplied via the substrate tube 103, for example, a mixed gas of methane (CH₄) and water vapor to be reformed into hydrogen (H₂) and carbon monoxide (CO). Further, the fuel-side electrode 109 electrochemically reacts hydrogen (H₂) and carbon monoxide (CO) obtained by the reformation with oxygen ions (O²⁻) supplied via the electrolyte 111 in the vicinity of the interface with the electrolyte 111 to produce water (H₂O) and carbon dioxide (CO₂). At this time, the fuel cells 105 generate electricity by electrons emitted from oxygen ions.

The fuel gas, which can be supplied and used for the fuel-side electrode 109 of the solid oxide fuel cell, includes, for example a gasification gas produced from carbon-containing raw materials such as petroleum, methanol, and coal by a gasification facility, in addition to hydrocarbon gas such as hydrogen (H₂) and carbon monoxide (CO), methane (CH₄), city gas, or natural gas.

As the electrolyte 111, YSZ is mainly used which has a gas-tight property that makes it difficult for a gas to pass through and a high oxygen ion conductive property at high temperature. The electrolyte 111 moves the oxygen ions (O²⁻) generated in the oxygen-side electrode to the fuel-side electrode. The electrolyte 111 located on a surface of the fuel-side electrode 109 has a film thickness of 10 μm to 100 μm, and the electrolyte 111 may be formed by screen-printing the slurry.

The oxygen-side electrode 113 is composed of, for example, LaSrMnO₃ system oxide or LaCoO₃ system oxide, and the oxygen-side electrode 113 is coated with the screen-printed slurry or a dispenser. The oxygen-side electrode 113 dissociates oxygen in the oxidizing gas such as supplied air to generate oxygen ions (O²⁻), in the vicinity of the interface with the electrolyte 111.

The oxygen-side electrode 113 can also have a two-layer structure. In this case, the oxygen-side electrode layer (oxygen-side electrode intermediate layer) on the electrolyte 111 side is made of a material which shows a high ion conductive property and is excellent in catalytic activity. The oxygen-side electrode layer (oxygen-side electrode conductive layer) on the oxygen-side electrode intermediate layer may be composed of a perovskite-type oxide represented by Sr and Ca-doped LaMnO₃. Thus, it is possible to further improve power generation performance.

The oxidizing gas is a gas containing approximately 15% to 30% of oxygen, and air is representatively suitable. However, besides air, a mixed gas of a combustion exhaust gas and air, a mixed gas of oxygen and air, or the like can be used.

The interconnector 107 is composed of a conductive perovskite-type oxide represented by M₁₋ₓLₓTiO₃ (M is an alkaline earth metal element, L is a lanthanoid element) such as SrTiO₃ system, and screen-prints the slurry. The interconnector 107 has a dense film so that the fuel gas and the oxidizing gas do not mix with each other. Further, the interconnector 107 has stable durability and electrical conductivity under both an oxidizing atmosphere and a reducing atmosphere. In the adjacent fuel cells 105, the interconnector 107 electrically connects the oxygen-side electrode 113 of the one fuel cell 105 and the fuel-side electrode 109 of the other fuel cell 105, and connects the adjacent fuel cell cells 105 to each other in series.

The lead film 115 needs to have electron conductivity and a thermal expansion coefficient close to that of another material constituting the cell stack 101, and is thus composed of a composite material of Ni such as Ni/YSZ and a zirconia-based electrolyte material or M₁₋ₓLₓTiO₃ (M is an alkaline earth metal element, L is a lanthanoid element) such as SrTiO₃ system. The lead film 115 derives the DC power which is generated by the plurality of fuel cells 105 connected in series by the interconnector 107 to the vicinity of the end of the cell stack 101.

In some embodiments, instead of separately providing the fuel-side electrode or the oxygen-side electrode and the substrate tube as described above, the fuel-side electrode or the oxygen-side electrode may thickly be formed to also serve as the substrate tube. Further, although the substrate tube in the present embodiment is described with the substrate tube having the cylindrical shape, a cross section of the substrate tube is not necessarily limited to a circular shape but may be, for example, an elliptical shape, as long as the substrate tube has a tubular shape. A cell stack may be used which has, for example, a flat tubular shape obtained by vertically squeezing a peripheral side surface of the cylinder.

(Configuration of Fuel Cell Power Generation System)

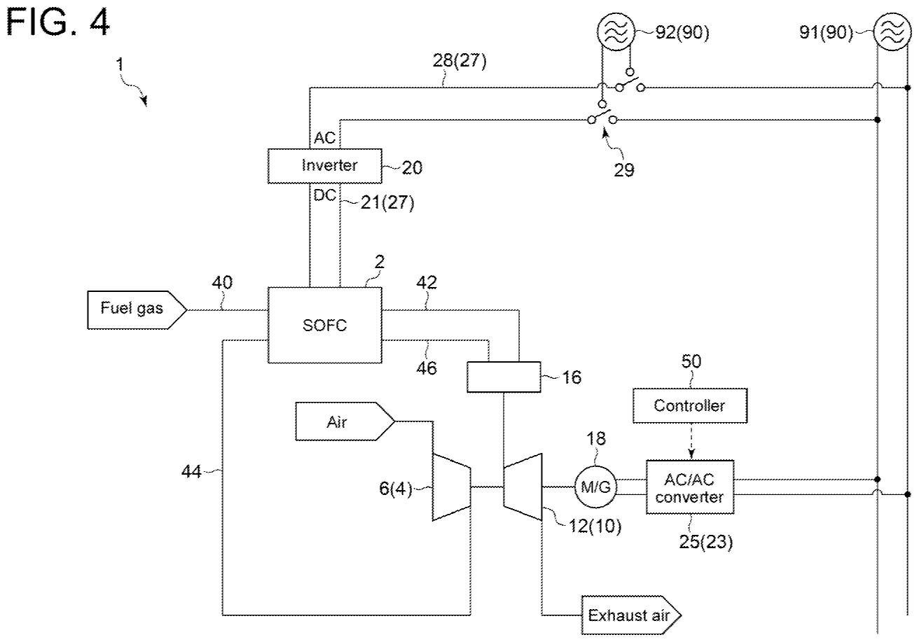

Next, the fuel cell power generation system (hereinafter, also referred to as the “power generation system”) according to some embodiments will be described with reference to FIGS. 4 to 10. FIGS. 4 to 10 are each a schematic view showing the configuration of the fuel cell power generation system according to an embodiment.

As shown in FIGS. 4 to 10, a power generation system (fuel cell power generation system) 1 according to an embodiment includes a fuel cell part 2 (fuel cell) with the fuel cell module 201 (see FIG. 1), and an inverter 20 disposed between the fuel cell part 2 and a power grid 90.

The inverter 20 is disposed on a power transmission line 27 that connects the power grid 90 and an output terminal of the fuel cell part 2. The power transmission line 27 includes a first DC electric circuit 21 which is a DC electric wire between the fuel cell part 2 and the inverter 20, and an AC electric circuit 28 between the inverter 20 and the power grid 90. The inverter 20 is configured to be capable of converting the DC power supplied from the fuel cell part 2 to AC power and supplying the AC power to the power grid 90 via the power transmission line 27. Between the inverter 20 and the power grid 90, a switching device 29 for switching connection states between the inverter 20 and the power grid 90 may be provided.

The power grid 90 may be a power grid 91 managed by an electric power company, or may be an independent power supply grid 92 different from the power grid 91. Further, the switching device 29 may be configured to be capable of switching a connection destination of the inverter 20 between the power grid 91 and the independent power supply grid 92 described above.

A load fluctuation absorbing storage cell (not shown) for storing the electric power generated by the fuel cell part 2 may be connected to the first DC electric circuit 21 between the inverter 20 and the fuel cell part 2. By storing the electric power generated by the fuel cell part 2 in the load fluctuation absorbing storage cell in advance, it is possible to flexibly meet an output demand from the power grid 90.

The fuel cell part 2 is connected to a fuel supply line 40, an exhaust fuel gas line 42, an oxidant supply line 44, and an oxidant exhaust line 46.

The fuel supply line 40 is configured to supply the fuel gas to the fuel-side electrode 109 of the fuel cell module 201 (fuel cell part 2) (that is, the fuel-side electrode 109 of the fuel cell 105 constituting the fuel cell module 201). The fuel supply line 40 is provided with a fuel control valve (not shown) for controlling the amount of fuel supplied to the fuel cell module 201. The exhaust fuel gas line 42 is configured such that the exhaust fuel gas from the fuel cell part 2 flows.

The oxidant supply line 44 is configured to supply the oxidizing gas (such as air) to the oxygen-side electrode 113 of the fuel cell module 201 (fuel cell part 2) (that is, the oxygen-side electrode 113 of the fuel cell 105 constituting the fuel cell module 201). The oxidant exhaust line 46 is configured such that the exhaust oxidized gas from the fuel cell part 2 flows.

The above-described fuel supply line 40 corresponds to the fuel gas supply pipe 207 or the fuel gas supply branch pipe 207a (see FIG. 1) in the fuel cell module 201. Further, the above-described oxidant supply line 44 corresponds to the oxidizing gas supply pipe or the oxidizing gas supply branch pipe (not shown in FIG. 1) in the fuel cell module 201.

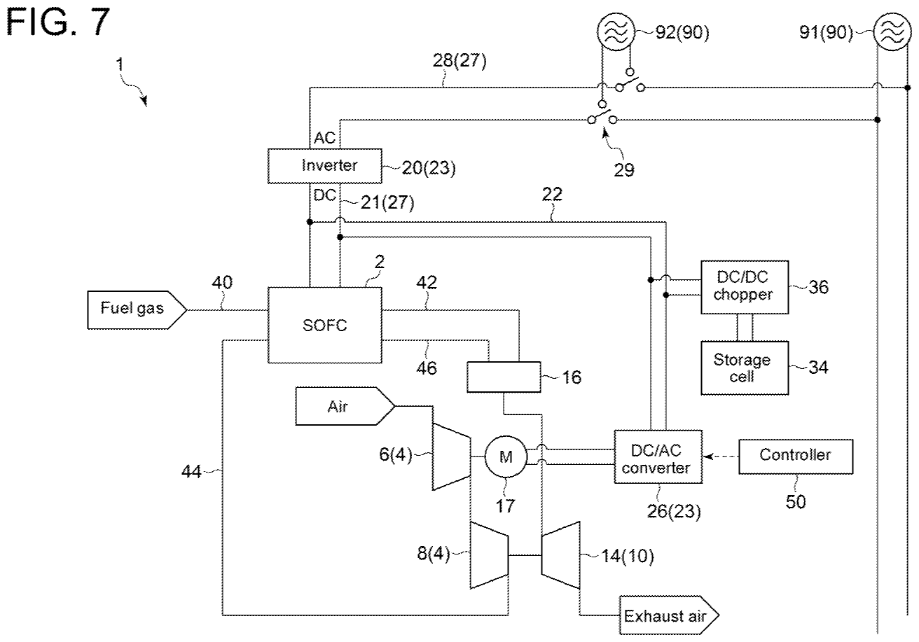

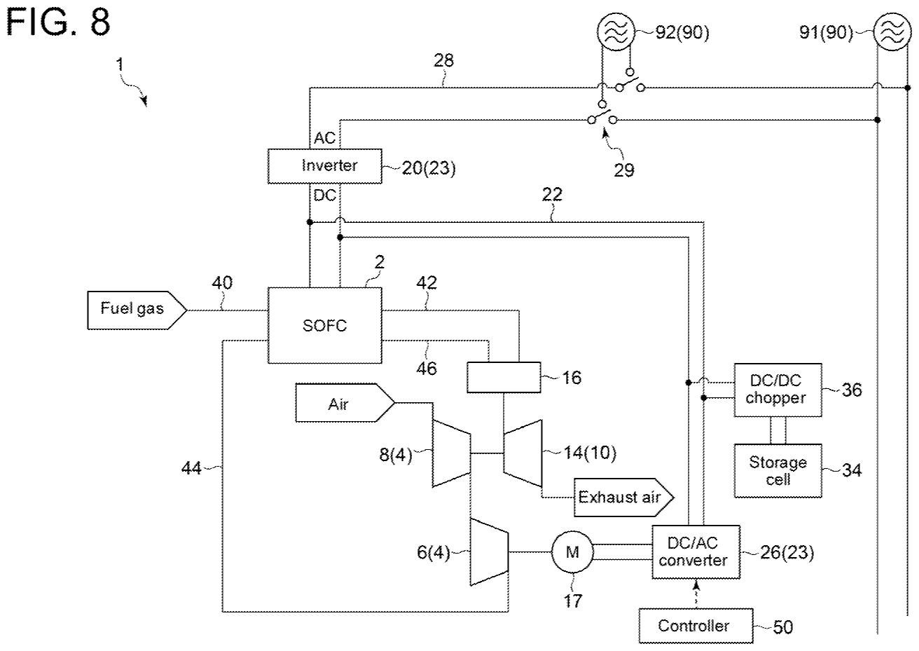

The power generation system 1 shown in FIGS. 4 to 10 includes at least one compressor 4 disposed on the oxidant supply line 44, a first motor (a motor/generator 18 or a motor 17) configured to be capable of driving a first compressor 6 among the at least one compressor 4, and at least one power converter 23 disposed between the first motor and the power grid 90. In the exemplary embodiments shown in FIGS. 4, 5, 6, 9, and 10, the first motor includes the motor/generator 18 that can also be used as a generator. In the exemplary embodiments shown in FIGS. 7 and 8, the first motor includes the motor 17.

The at least one compressor 4 is configured to compress the oxidizing gas flowing through the oxidant supply line 44 (that is, the oxidizing gas supplied to the fuel cell part 2). By supplying the oxidizing gas pressurized by the compressor 4 to the oxygen-side electrode 113 of the fuel cell part 2 via the oxidant supply line 44, as compared with a case where the oxidizing gas is not pressurized, it is possible to increase power generation efficiency in the fuel cell part 2.

In some embodiments, the power generation system 1 may include a plurality of compressors 4 disposed in series on the oxidant supply line 44. In addition to the first compressor 6 that can be driven by the first motor (the motor/generator 18 or the motor 17), the plurality of compressors 4 may include a second compressor 8 configured to be driven by a drive source other than the first motor (the motor/generator 18 or the motor 17).

In the exemplary embodiments shown in FIGS. 4 to 6, the one compressor 4 is disposed on the oxidant supply line 44, and the said compressor 4 is the first compressor 6.

In the exemplary embodiments shown in FIGS. 7 to 10, the two compressors 4 are disposed in series on the oxidant supply line 44, one of which is the first compressor 6 and the other of which is the second compressor 8. In the exemplary embodiments shown in FIGS. 7, 9, and 10, the first compressor 6 is disposed upstream of the second compressor 8 on the oxidant supply line 44. In the exemplary embodiment shown in FIG. 8, the first compressor 6 is disposed downstream of the second compressor 8 on the oxidant supply line 44.

The power generation system 1 may include a turbine 10 configured to be driven by the exhaust gas from the fuel cell part 2 and configured to drive any of the at least one compressor 4. Herein, the exhaust gas from the fuel cell part 2 is a gas derived from the exhaust fuel gas or the exhaust oxidized gas from the fuel cell part 2 and may be, for example, a combustion gas generated by combusting the exhaust fuel gas from the fuel cell part 2. With the turbine 10, it is possible to drive the compressor 4 by using the energy of the exhaust gas from the fuel cell part 2, making it possible to continuously operate the power generation system 1 including the fuel cell part 2.

In the exemplary embodiments shown in FIGS. 4 to 10, the power generation system 1 includes a combustor 16 which is configured to combust an unused fuel component (methane, hydrogen, carbon monoxide, or the like) contained in the exhaust fuel gas from the fuel cell part 2, and the turbine 10 is driven by the combustion gas generated by the combustor 16. The exhaust fuel gas and the exhaust oxidized gas from the fuel cell part 2 are supplied to the combustor 16 via the exhaust fuel gas line 42 and the oxidant exhaust line 46, respectively, and the unused fuel component in the exhaust fuel gas is combusted by using oxygen in the exhaust oxidized gas as an oxidizing agent.

In the exemplary embodiments shown in FIGS. 4 to 6, 9, and 10, the turbine 10 includes a first turbine 12 configured to drive the first compressor 6. The first turbine 12 and the first compressor 6 are connected via a rotational shaft, and if the first turbine 12 is rotary driven by the combustion gas from the combustor 16, the first compressor 6 connected to the first turbine 12 via the rotational shaft is rotary driven. That is, the first turbine 12 constitutes a turbocharger together with the first compressor 6.

In the exemplary embodiments shown in FIGS. 7 to 10, the turbine 10 includes a second turbine 14 configured to drive the second compressor 8. The second turbine 14 and the second compressor 8 are connected via a rotational shaft, and if the second turbine 14 is rotary driven by the combustion gas from the combustor 16, the second compressor 8 connected to the second turbine 14 via the rotational shaft is rotary driven. That is, the second turbine 14 constitutes a turbocharger together with the second compressor 8.

The first motor (the motor/generator 18 or the motor 17) may be connected to, via the power converter 23, the power grid 90 (the power grid 91 in the illustrated example) or the first DC electric circuit 21 (a portion of the power transmission line 27 between the inverter 20 and the fuel cell part 2).

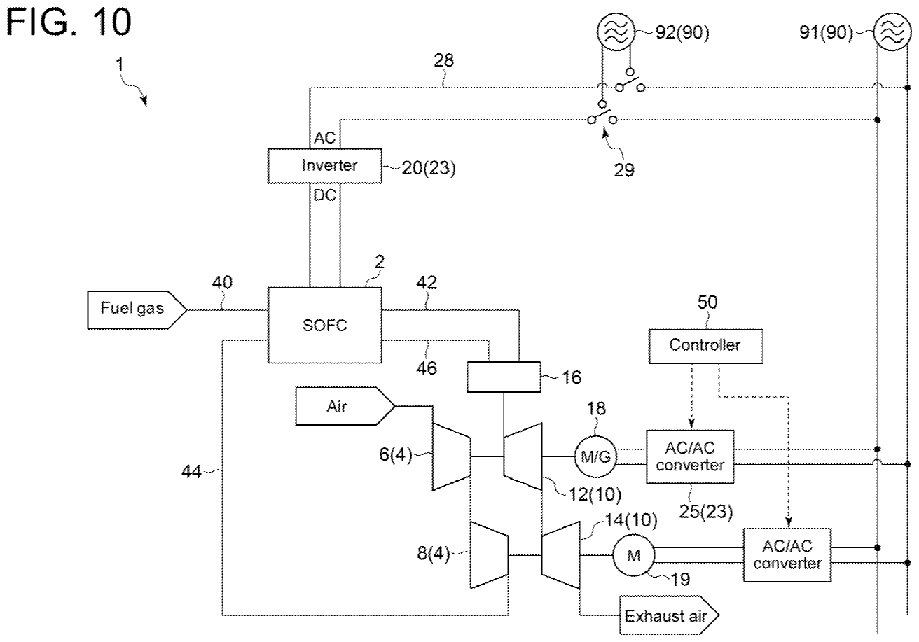

In the exemplary embodiments shown in FIGS. 4 and 10, the power converter 23 includes an AC/AC converter 25 disposed between the first motor (motor/generator 18) and the power grid 90, and the first motor (motor generator 18) is connected to the power grid 91 via the AC/AC converter 25. The AC/AC converter 25 is configured to be capable of appropriately converting a voltage and/or frequency of AC power from the power supply grid 91 and supplying it to the first motor (motor/generator 18). By thus driving the first motor (motor/generator 18), it is possible to drive the first compressor 6. That is, electric power from the power grid 90 can be supplied to the first motor (motor/generator 18) via the AC/AC converter 25 or without via the inverter 20 and the first DC electric circuit 21.

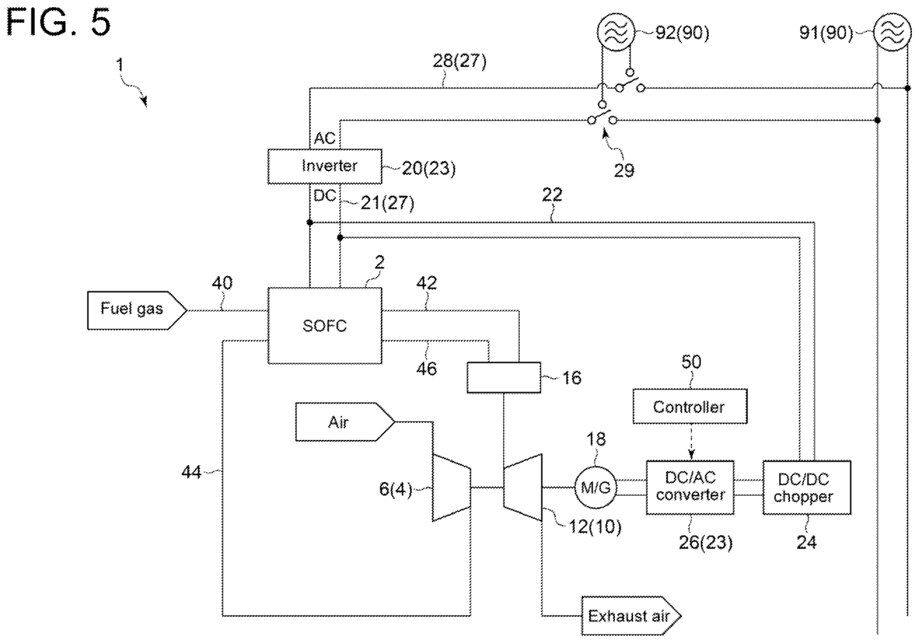

In the exemplary embodiments shown in FIGS. 5 to 9, the power converter 23 includes a DC/AC converter 26 disposed between the first motor (the motor/generator 18 or the motor 17) and the second DC electric circuit 22 (the portion of the power transmission line 27 between the inverter 20 and the fuel cell part 2) and the inverter 20, and the first motor (the motor/generator 18 or the motor 17) is connected to the DC/AC converter 26 and the first DC electric circuit 21 via the second DC electric circuit 22. The DC/AC converter 26 is configured to be capable of converting DC power from the second DC electric circuit 22 into AC power and supplying it to the first motor (the motor/generator 18 or the motor 17). By thus driving the first motor (the motor/generator 18 or the motor 17), it is possible to drive the first compressor 6. That is, the first motor (the motor/generator 18 or the motor 17) can be supplied with the electric power from the power grid 90 via the inverter 20 (power converter 23), the first DC electric circuit 21, the second DC electric circuit 22, and the DC/AC converter 26 (power converter 23), and can be supplied with the electric power from the fuel cell part 2 via the first DC electric circuit 21, the second DC electric circuit 22, and the DC/AC converter 26 (power converter 23).

For example, as shown in FIGS. 5, 6, and 9, the first motor may be the motor/generator 18 that functions as the generator which is driven by the first turbine 12 connected to the first compressor 6. That is, the first motor (motor/generator 18) may be configured to be capable of regenerative operation. Thus, if an undue output is generated in the first turbine 12, it is possible to recover surplus energy by performing the regenerative operation with the first motor (motor/generator 18), and it is possible to improve the efficiency of the power generation system 1. The AC power, which is generated by the first motor (motor/generator 18) operating as the generator, may be converted into DC power by the DC/AC converter 26 and transmitted to the second DC electric circuit 22. On the second DC electric circuit 22, between the DC/AC converter 26 and the first DC electric circuit 21, a DC/DC chopper 24 for adjusting the voltage of the DC power from the DC/AC converter 26 may be provided.

As described above, in the power generation system 1 where the oxidizing gas, which is pressurized by driving the turbocharger (the first turbine 12 and the first compressor 6, or the second turbine 14 and the second compressor 8) with the exhaust gas from the fuel cell part 2, is supplied to the fuel cell part 2, the output of the turbine 10 (the first turbine 12 or the second turbine 14) depends on the amount of the exhaust gas or the temperature of the exhaust gas at the inlet of the turbine 10. Therefore, after the power generation system 1 is started, after the temperature of the power generation chamber 215 (see FIG. 2) of the fuel cell part 2 and the temperature of the exhaust gas moderately increase and self-sustained operation of the turbocharger is established, the turbocharger can continue the self-sustained operation at a rotation speed within a predetermined range if there is no change in power generation amount of the fuel cell part 2. The self-sustained operation of the turbocharger means a state in which the turbocharger operates stably only with the exhaust gas from the fuel cell part 2 without assistance of the motor, the starting compressor, or the like. By contrast, when the power generation system 1 is started, the turbocharger increases the rotation speed and the exhaust amount of the oxidizing gas with the assistance of the motor, the starting compressor, or the like.

Meanwhile, the oxidizing gas supply amount to the fuel cell part 2 needs to be a supply amount commensurate with an output demand value of the fuel cell part 2, in order to maintain the temperature of the power generation chamber 215 of the fuel cell part 2 within an appropriate range (within a temperature range where the power generation efficiency by the fuel cell part 2 does not decrease, or the fuel cell part 2 is protected from an excessively high temperature) according to the power generation output. Therefore, when the output demand value of the fuel cell part 2 is changed due to a change in power demand, it is necessary to supply the fuel cell part 2 with the oxidizing gas by the amount commensurate with the changed output demand value. Thus, in order to achieve the desired oxidizing gas supply amount, it is necessary to increase or decrease the rotation speed of the compressor 4 (the first compressor 6 or the second compressor 8).

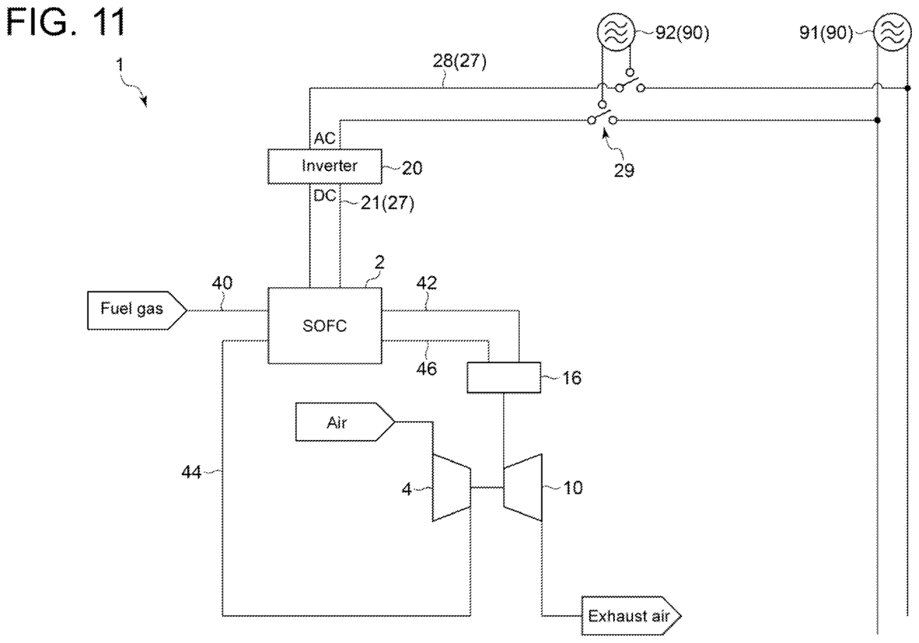

Herein, since a system internal volume of the fuel cell part 2 is relatively large, it is difficult to rapidly increase or decrease the amount of the exhaust gas from the fuel cell part 2 and the temperature of the exhaust gas, and it is difficult to rapidly change the output of the turbine 10 (the first turbine 12 or the second turbine 14). Thus, in the power generation system where the compressor is driven only by the turbine 10 as shown in FIG. 11, it is impossible to rapidly change the oxidizing gas supply amount according to the change in output demand value of the fuel cell part 2. As a result, it is difficult to increase an output change rate of the fuel cell part 2.

In this regard, in the above-described embodiments, since the first motor (the motor/generator 18 or the motor 17) is assisted by the electric power supplied from the power grid 90 or the fuel cell part 2, it is configured such that the oxidizing gas compressed by the first compressor 6 can be supplied to the fuel cell part 2 to have the desired change amount according to the change in output demand value. Then, by controlling the torque of the first motor (the motor/generator 18 or the motor 17) with the power converter 23 (the AC/AC converter 25 or the DC/AC converter 26), the rotation speed of the first compressor 6 can be adjusted according to the oxidizing gas supply amount corresponding to the output demand value of the fuel cell part 2. Thus, it is possible to rapidly change the oxidizing gas supply amount to the fuel cell part 2. For example, when it becomes necessary to change the output of the fuel cell part 2, even if the exhaust gas from the fuel cell part 2 for driving the turbine 10 does not have sufficient energy, by offsetting the shortage with the first motor (the motor/generator 18 or the motor 17), it is possible to rapidly adjust the rotation speed of the first compressor 6 and rapidly change the oxidizing gas supply amount to the fuel cell part 2. Thus, it is possible to increase the output change rate of the fuel cell part 2, and it is possible to improve load responsiveness of the power generation system 1 including the fuel cell part 2. Further, thus, by storing the electric power generated by the fuel cell part 2, it is possible to output the electric power with good responsiveness according to the change in output demand. Therefore, it may be possible to omit installation of a large-capacity storage cell for absorbing a load fluctuation.

Further, for example, as in the embodiments shown in FIGS. 5 to 9, in the case where the inverter 20 is shared by the fuel cell part 2 and the first motor (the motor/generator 18 or the motor 17), it is possible to reduce a facility cost. Thus, it is possible to increase the output change rate of the fuel cell part 2 and to improve load followability of the fuel cell part 2, while reducing the facility cost.

As shown in FIGS. 4 to 10, the power generation system 1 may further include a controller 50 for controlling the power converter 23 (the AC/AC converter 25 or the DC/AC converter 26). The controller 50 may be configured to control the power converter 23 (the AC/AC converter 25 or the DC/AC converter 26) so as to adjust the torque of the first motor (the motor/generator 18 or the motor 17), such that the oxidizing gas supply amount to the fuel cell part 2 corresponding to the output demand value of the fuel cell part 2 is achieved, that is, the rotation speed of the first compressor 6 is obtained at which such oxidizing gas supply amount is achieved.

More specifically, in an embodiment, the controller 50 may be configured as follows. That is, the controller 50 receives the output demand value (demand) of the fuel cell from a central power distribution station (dispatch center). Then, the controller 50 calculates the torque of the first motor (the motor/generator 18 or the motor 17) for achieving the target rotation speed of the first compressor 6 required to obtain the oxidizing gas supply amount corresponding to the output demand value, and generates a PWM control command to be applied to the power converter 23 (the AC/AC converter 25 or the DC/AC converter 26) from an active current required to obtain the calculated torque of the first motor (the motor/generator 18 or the motor 17). Based on the PWM control command thus generated, by performing switching control of a switching element (for example, IGBT) of the power converter 23 (the AC/AC converter 25 or the DC/AC converter 26), the torque of the first motor (the motor/generator 18 or the motor 17) is adjusted to a desired value.

Since the controller 50 thus controls the power converter 23 (the AC/AC converter 25 or the DC/AC converter 26), it is possible to appropriately adjust the rotation speed of the first compressor 6 according to the oxidizing gas supply amount corresponding to the output demand value of the fuel cell part 2. Thus, it is possible to rapidly change the oxidizing gas supply amount to the fuel cell part 2, it is possible to increase the output change rate of the fuel cell part 2, and it is possible to improve load followability.

When the output demand value of the fuel cell part 2 increases as power demand increases, a target supply amount of the oxidizing gas to the fuel cell part 2 also increases in response to the output demand value. Thus, the controller 50 calculates the torque of the first motor (the motor/generator 18 or the motor 17) that makes it possible to obtain the rotation speed of the first compressor 6 at which the target supply amount is achieved, and controls the power converter 23 (the AC/AC converter 25 or the DC/AC converter 26) based on the torque, thereby applying a voltage to the first motor (the motor/generator 18 or the motor 17).

Further, when the output demand value of the fuel cell part 2 decreases as the power demand decreases, the target supply amount of the oxidizing gas to the fuel cell part 2 also decreases in response to the output demand value. Thus, the controller 50 calculates the torque of the first motor (the motor/generator 18 or the motor 17) so that the rotation speed of the first compressor 6 at which the target supply amount is achieved can be obtained, and controls the power converter 23 (the AC/AC converter 25 or the DC/AC converter 26) based on the torque. At this time, as in the embodiments shown in FIGS. 5, 6, and 9, if the first motor (motor/generator 18) is driven by the turbine 10 and is configured to function as the generator, the first motor (motor/generator 18) may perform regenerative operation until the torque of the first motor (motor/generator 18) reaches the calculated target value. Alternatively, in an embodiment, the oxidizing gas supply amount to the fuel cell part 2 and the exhaust oxidized gas amount from the fuel cell part 2 may be reduced by adjusting the opening degree of a bypass valve (not shown) of a bypass line (not shown) disposed so as to branch from the oxidant supply line 44 and to bypass the fuel cell part 2, such that the torque of the first motor (the motor/generator 18 or the motor 17) reaches the calculated target value.

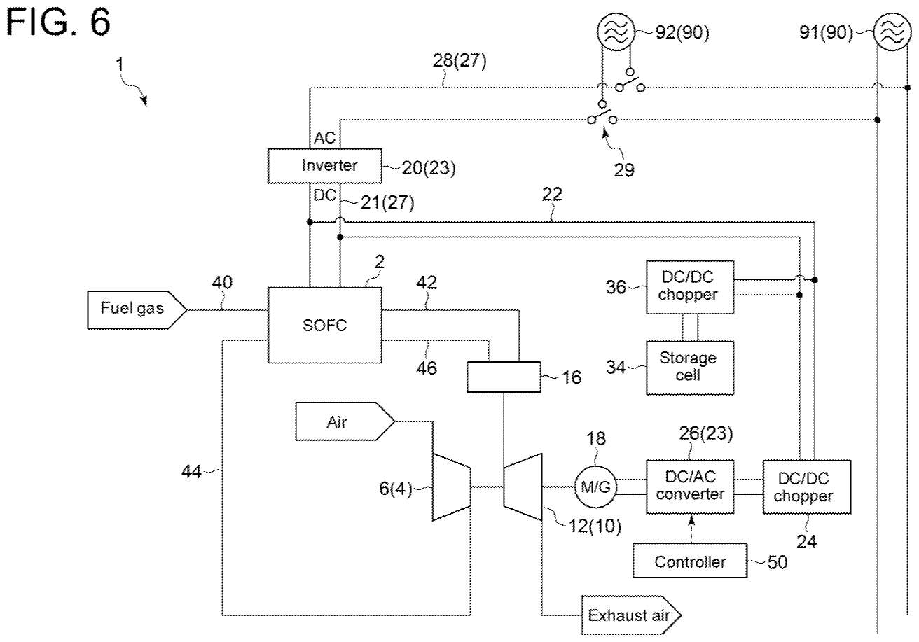

In some embodiments, for example, as shown in FIGS. 6 to 9, the power generation system 1 may include a motor storage cell 34 connected to the second DC electric circuit 22 between the inverter 20 and the first motor (the motor/generator 18 or the motor 17). Between the motor storage cell 34 and the second DC electric circuit 22, a DC/DC chopper 36 for adjusting a voltage of DC power from the motor storage cell 34 may be provided.

According to the above-described embodiments, it is possible to drive the first motor (the motor/generator 18 or the motor 17) by the electric power which is supplied from the motor storage cell 34 connected to the second DC electric circuit 22 between the inverter 20 and the first motor (the motor/generator 18 or the motor 17). Thus, even if the power supply from the power grid 90 cannot be received, such as when the grid is shut off, the first motor (the motor/generator 18 or the motor 17) is driven by the power supply from the motor storage cell 34, thereby driving the first compressor 6, which allows for appropriate operation of the power generation system 1 including the fuel cell part 2. Further, since the motor storage cell 34 is connected to the second DC electric circuit 22 between the first motor (the motor/generator 18 or the motor 17) and the inverter 20 disposed between the fuel cell part 2 and the power grid 90, it is not necessary to separately provide an inverter for the motor storage cell 34, which is different from the inverter 20. Furthermore, it is sufficient that the motor storage cell 34 can supply electric power required to assist the driving of the first compressor 6, and a relatively small-capacity cell will suffice. Thus, it is possible to suppress an increase in cost.

In some embodiments (for example, the embodiments shown in FIGS. 5 and 8), the electric power generated by the regenerative operation by the first motor (motor/generator 18) may be stored in the motor storage cell 34.

As already described, in the exemplary embodiments shown in FIGS. 7 to 10, the power generation system 1 includes the second compressor 8 disposed in series with the first compressor 6 on the oxidant supply line 44.

In the above-described embodiments, since the first compressor 6 and the second compressor 8 disposed in series with the first compressor 6 are used in combination, it is possible to adopt a relatively low-capacity compressor as the first compressor 6. Thus, as to the first motor (the motor/generator 18 or the motor 17) for driving the first compressor 6 as well, it is possible to adopt a motor with relatively small output, making it possible to improve load followability of the fuel cell while effectively suppressing the increase in cost.

Further, in the exemplary embodiments shown in FIGS. 7 to 10, the power generation system 1 includes the second turbine 14 configured to drive the second compressor 8. That is, the power generation system 1 includes the turbocharger that includes the second compressor 8 disposed on the oxidant supply line 44, and the second turbine 14 connected to the second compressor 8 via the rotational shaft and configured to be driven by the exhaust gas from the fuel cell part 2.

According to the above-described embodiments, the first compressor 6 driven by the first motor (the motor/generator 18 or the motor 17) and the second compressor 8 driven by the second turbine 14 are used in combination. Thus, when it becomes necessary to change the output of the fuel cell part 2, even if the exhaust gas of the fuel cell part 2 for driving the turbine 14 does not have sufficient energy, by offsetting the shortage with the first motor (the motor/generator 18 or the motor 17), it is possible to rapidly adjust the rotation speed of the first compressor 6 and rapidly change the oxidizing gas supply amount to the fuel cell part 2. Thus, it is possible to increase the output change rate of the fuel cell part 2, and it is possible to improve load followability of the fuel cell part 2.

Further, in the embodiment shown in FIG. 10, the power generation system 1 includes the second turbine 14 and a second motor 19 configured to drive the second compressor 8. That is, the power generation system 1 includes the turbocharger that includes the second compressor 8 disposed on the oxidant supply line 44, and the second turbine 14 connected to the second compressor 8 via the rotational shaft and configured to be driven by the exhaust gas from the fuel cell part 2 and the second motor 19.

According to the above-described embodiment, the first compressor 6 driven by the first motor (the motor/generator 18 or the motor 17) and the second compressor 8 driven by the second turbine 14 and the second motor 19 are used in combination. Thus, even if the exhaust gas of the fuel cell part 2 for driving the second turbine 14 does not have sufficient energy, such as at the time of startup, by offsetting the shortage with the second motor 19 driven by electric power from the grid or the like, it is possible to adjust the rotation speed of the first compressor 6 to a required value and to obtain the desired oxidizing gas supply amount to the fuel cell part 2. Thus, it is possible to obtain smoother startup and the increased output change rate of the fuel cell part 2, and it is possible to improve load followability of the fuel cell part 2. The second motor 19 may be a motor/generator that can also be used as a generator.

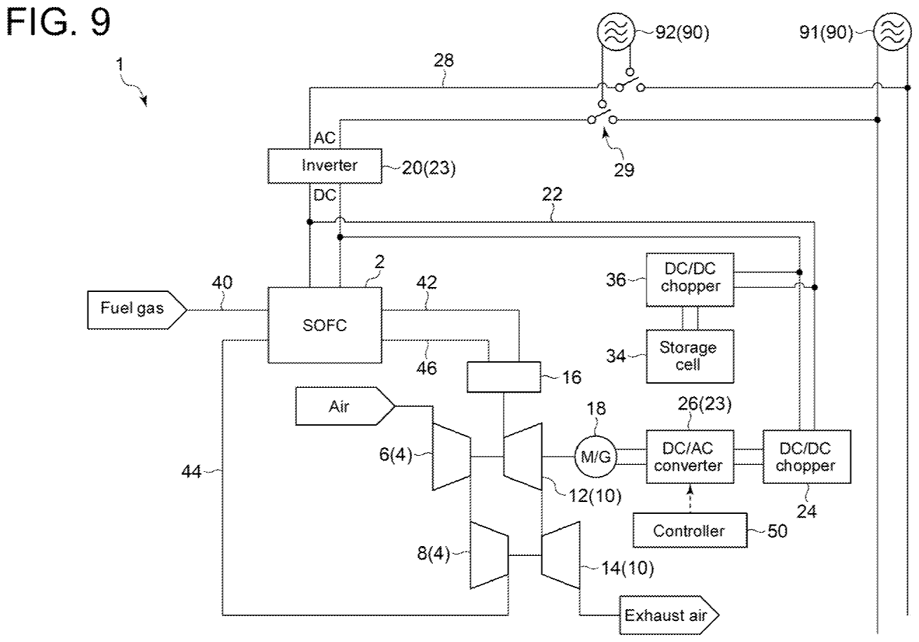

The power generation system 1 shown in FIGS. 7 and 8 can be obtained by additionally installing the first compressor 6 and the first motor (motor 17) on an existing power generation system including the second compressor 8 and the second turbine 14 (turbocharger). Further, the power generation system 1 shown in FIGS. 9 and 10 can be obtained by additionally installing the first compressor and the first turbine (turbocharger) as well as the first motor (motor/generator 18) on the existing power generation system including the second compressor 8 and the second turbine 14 (turbocharger).

That is, the power generation system 1 shown in FIGS. 7 to 10 can be obtained by additionally installing the first compressor 6 or the turbocharger (the first compressor 6 and the first turbine 12) that can be driven by the first motor (the motor/generator 18 or the motor 17) on the existing pressurized fuel cell power generation system including the second compressor 8 and the second turbine 14 (turbocharger). Therefore, the first compressor 6 or the turbocharger including the first compressor 6 can be installed independently of the existing turbocharger (the second compressor 8 and the second turbine 14), making it possible to freely arrange the facility or select a model.

The contents described in the above embodiments would be understood as follows, for instance.

(1) A fuel cell power generation system (1) according to at least one embodiment of the present invention includes: a fuel cell (such as the above-described fuel cell part 2); at least one compressor (4) disposed on an oxidant supply line (44) for supplying an oxidizing gas to the fuel cell; a first motor (such as the motor/generator 18 or the motor 17 described above) configured to drive a first compressor (6) among the at least one compressor; and at least one power converter (23) disposed between the first motor and a power grid (90), and capable of adjusting a torque of the first motor.

With the above configuration (1), since the first motor is driven by the electric power supplied from the power grid, the oxidizing gas compressed by the first compressor can be supplied to the fuel cell. Further, by controlling the torque of the first motor with the power converter, the rotation speed of the first compressor can be adjusted according to the oxidizing gas supply amount corresponding to the output demand value of the fuel cell. Thus, it is possible to rapidly change the oxidizing gas supply amount to the fuel cell and it is possible to increase the output change rate of the fuel cell. Thus, it is possible to improve load followability of the fuel cell.

(2) In some embodiments, in the above configuration (1), the fuel cell power generation system includes: a controller (50) for controlling the power converter so as to adjust the torque of the first motor, such that a supply amount of the oxidizing gas to the fuel cell corresponding to an output demand value of the fuel cell is achieved.

With the above configuration (2), since the controller controls the power converter, it is possible to appropriately adjust the rotation speed of the first compressor according to the oxidizing gas supply amount corresponding to the output demand value of the fuel cell. Thus, it is possible to rapidly change the oxidizing gas supply amount to the fuel cell, it is possible to increase the output change rate of the fuel cell, and it is possible to improve load followability.

(3) In some embodiments, in the above configuration (1) or (2), the at least one power converter includes an AC/AC converter (25) disposed between the power grid and the first motor.

With the above configuration (3), the torque of the first motor can appropriately be controlled by the AC/AC converter disposed in the AC electric circuit. Thus, since the rotation speed of the first compressor can be adjusted according to the oxidizing gas supply amount corresponding to the output demand value of the fuel cell, it is possible to rapidly change the oxidizing gas supply amount to the fuel cell and it is possible to increase the output change rate of the fuel cell.

(4) In some embodiments, in the above configuration (1) or (2), the at least one power converter includes: an inverter (20) disposed between the fuel cell and the power grid; and a DC/AC converter (25) disposed with a first DC electric circuit between the fuel cell and the inverter.

With the above configuration (4), since the first motor is driven by the electric power supplied from the power grid or the fuel cell, the oxidizing gas compressed by the first compressor can be supplied to the fuel cell. Further, the torque of the first motor can appropriately be controlled by the inverter and/or the DC/AC converter. Thus, since the rotation speed of the first compressor can be adjusted according to the oxidizing gas supply amount corresponding to the output demand value of the fuel cell, it is possible to rapidly change the oxidizing gas supply amount to the fuel cell and it is possible to increase the output change rate of the fuel cell. Further, since the inverter is shared by the fuel cell and the first motor, it is possible to reduce a facility cost. Thus, it is possible to increase the output change rate of the fuel cell and to improve load followability of the fuel cell, while reducing the facility cost.

(5) In some embodiments, in the above configuration (4), the fuel cell power generation system includes: a motor storage cell (34) connected to a second DC electric circuit (22) between the inverter and the first motor.

With the above configuration (5), it is possible to drive the first motor by the electric power which is supplied from the motor storage cell connected to the second DC electric circuit between the inverter and the first motor. Thus, even if the power supply from the power grid cannot be received, such as when the grid is shut off, the first motor is driven by the power supply from the motor storage cell, thereby assisting the driving of the first compressor, which allows for the increase in output change rate of the fuel cell. Further, since the motor storage cell is connected to the second DC electric circuit between the first motor and the inverter disposed between the fuel cell and the power grid, it is not necessary to separately provide the inverter for the motor storage cell, which is different from the aforementioned inverter. Furthermore, it is sufficient that the motor storage cell can supply electric power required to assist the driving of the first compressor, and a relatively small-capacity cell will suffice. Thus, it is possible to suppress an increase in cost.

(6) In some embodiments, in any one of the above configurations (1) to (5), the fuel cell power generation system includes: at least one turbine (10) configured to be driven by an exhaust gas from the fuel cell and configured to drive any of the at least one compressor.

With the above configuration (6), the oxidizing gas that is compressed by the compressor which is driven by the turbine driven by the exhaust gas from the fuel cell can be supplied to the fuel cell. Further, when it becomes necessary to change the output of the fuel cell, even if the exhaust gas of the fuel cell for driving the turbine does not have sufficient energy, by offsetting the shortage with the first motor, it is possible to rapidly adjust the rotation speed of the first compressor and rapidly change the oxidizing gas supply amount to the fuel cell. Thus, it is possible to increase the output change rate of the fuel cell, and it is possible to improve load followability of the fuel cell.

(7) In some embodiments, in the above configuration (6), the at least one turbine includes a first turbine (12) configured to drive the first compressor.

With the above configuration (7), the first compressor can be driven by the first motor, in addition to being driven by the first turbine driven by the exhaust gas from the fuel cell. Thus, when it becomes necessary to change the output of the fuel cell, even if the exhaust gas of the fuel cell for driving the first turbine does not have sufficient energy, by offsetting the shortage with the first motor, it is possible to rapidly adjust the rotation speed of the first compressor and rapidly change the oxidizing gas supply amount to the fuel cell. Thus, it is possible to increase the output change rate of the fuel cell, and it is possible to improve load followability of the fuel cell.

(8) In some embodiments, in the above configuration (7), the first motor is configured to be driven by the first turbine and is configured to be capable of regenerative operation.

With the above configuration (8), if an undue output is generated in the first turbine, it is possible to recover surplus energy by performing the regenerative operation with the first motor. Thus, it is possible to improve the efficiency of the fuel cell power generation system.

(9) In some embodiments, in any one of the above configurations (6) to (8), the at least one compressor includes a second compressor (8) disposed in series with the first compressor on the oxidant supply line.

With the above configuration (9), since the first compressor and the second compressor disposed in series with the first compressor are used in combination, it is possible to adopt the relatively low-capacity compressor as the first compressor. Thus, as to the first motor for driving the first compressor as well, it is possible to adopt the motor with relatively small output, making it possible to improve load followability of the fuel cell while effectively suppressing the increase in cost.

(10) In some embodiments, in the above configuration (9), the at least one turbine includes a second turbine (14) configured to drive the second compressor.

With the above configuration (10), the first compressor driven by the first motor and the second compressor driven by the second turbine are used in combination. Thus, when it becomes necessary to change the output of the fuel cell, even if the exhaust gas of the fuel cell for driving the second turbine does not have sufficient energy, by offsetting the shortage with the first motor, it is possible to rapidly adjust the rotation speed of the first compressor and rapidly change the oxidizing gas supply amount to the fuel cell. Thus, it is possible to increase the output change rate of the fuel cell, and it is possible to improve load followability of the fuel cell.

(11) In some embodiments, in the above configuration (9) or (10), the power generation system includes: a second motor (19) for driving the second compressor.

With the above configuration (11), the first compressor driven by the first motor and the second compressor 8 driven by the second motor are used in combination. Thus, even if the exhaust gas from the fuel cell for driving the second turbine does not have sufficient energy, such as at the time of startup, by offsetting the shortage with the second motor, it is possible to adjust the rotation speed of the first compressor to the required value and to obtain the desired oxidizing gas supply amount to the fuel cell. Thus, it is possible to obtain smoother startup and the increased output change rate of the fuel cell part, and it is possible to improve load followability of the fuel cell.

Embodiments of the present invention were described in detail above, but the present invention is not limited thereto, and also includes an embodiment obtained by modifying the above-described embodiments and an embodiment obtained by combining these embodiments as appropriate.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, an expression of a shape such as a rectangular shape or a cylindrical shape shall not be construed as only the geometrically strict shape, but also includes a shape with unevenness or chamfered corners within the range in which the same effect can be achieved.

As used herein, the expressions “comprising”, “including” or “having” one constitutional element is not an exclusive expression that excludes the presence of other constitutional elements.

### REFERENCE SIGNS LIST

1 Power generation system (fuel cell power generation system)
2 Fuel cell part
4 Compressor
6 First compressor
8 Second compressor
10 Turbine
12 First turbine
14 Second turbine
16 Combustor
17 Motor (first motor)
18 Motor/generator (first motor)
19 Second motor
20 Inverter
21 First DC electric circuit
22 Second DC electric circuit
23 Power converter
24 DC/DC chopper
25 AC/AC converter
26 DC/AC converter
27 Power transmission line
28 AC electric circuit
29 Switching device
30 Storage cell
34 Motor storage cell
36 DC/DC chopper
40 Fuel supply line
42 Exhaust fuel gas line
44 Oxidant supply line
46 Oxidant exhaust line
50 Controller
90 Power grid
91 Power grid
92 Independent power supply grid
101 Cell stack
103 Substrate tube
105 Fuel cell
107 Interconnector
109 Fuel-side electrode
111 Electrolyte
113 Oxygen-side electrode
115 Lead film
201 SOFC module (fuel cell module)
203 SOFC cartridge
205 Pressure vessel
207 Fuel gas supply pipe
207a Fuel gas supply branch pipe
209 Fuel gas exhaust pipe
209a Fuel gas exhaust branch pipe
215 Power generation chamber
217 Fuel gas supply header
219 Fuel gas exhaust header
221 Oxidizing gas supply header
223 Oxidizing gas exhaust header
225a Upper tube plate
225b Lower tube plate
227a Upper heat insulating body
227b Lower heat insulating body
229a Upper casing
229b Lower casing
231a Fuel gas supply hole
231b Fuel gas exhaust hole
233a Oxidizing gas supply hole
233b Oxidizing gas exhaust hole
235a Oxidizing gas supply gap
235b Oxidizing gas exhaust gap
237a Sealing member
237b Sealing member

1. A fuel cell power generation system, comprising:
a fuel cell;
at least one compressor disposed on an oxidant supply line for supplying an oxidizing gas to the fuel cell;
a first motor configured to drive a first compressor among the at least one compressor; and
at least one power converter disposed between the first motor and a power grid and capable of adjusting a torque of the first motor.

2. The fuel cell power generation system according to claim 1, comprising:
a controller for controlling the at least one power converter so as to adjust the torque of the first motor, such that a supply amount of the oxidizing gas to the fuel cell corresponding to an output demand value of the fuel cell is achieved.

3. The fuel cell power generation system according to claim 1,
wherein the at least one power converter includes an AC/AC converter disposed between the power grid and the first motor.

4. The fuel cell power generation system according to claim 1,
wherein the at least one power converter includes:
an inverter disposed between the fuel cell and the power grid; and
a DC/AC converter disposed with a first DC electric circuit between the fuel cell and the inverter.

5. The fuel cell power generation system according to claim 4, comprising:
a motor storage cell connected to a second DC electric circuit between the inverter and the first motor.

6. The fuel cell power generation system according to claim 1, comprising:
at least one turbine configured to be driven by an exhaust gas from the fuel cell and configured to drive any of the at least one compressor.

7. The fuel cell power generation system according to claim 6,
wherein the at least one turbine includes a first turbine configured to drive the first compressor.

8. The fuel cell power generation system according to claim 7,
wherein the first motor is configured to be driven by the first turbine and is configured to be capable of regenerative operation.

9. The fuel cell power generation system according to claim 6,
wherein the at least one compressor includes a second compressor disposed in series with the first compressor on the oxidant supply line.

10. The fuel cell power generation system according to claim 9,
wherein the at least one turbine includes a second turbine configured to drive the second compressor.

11. The fuel cell power generation system according to claim 9, comprising:
a motor for driving the second compressor.
